(19) United States
(12) Patent Application Publication
(10) Pub. No.: US 2011/0128347 A1
(43) Pub. Date: Jun. 2, 2011

(54) Miniature Camera Module

(76) Inventor: Daniel Theobald, Sommerville, MA (US)

(21) Appl. No.: 12/626,983

(22) Filed: Nov. 30, 2009

(51) Int. Cl. H04N 7/00; H04N 5/225

(52) U.S. Cl. 348/36; 348/373; 348/E05.024; 348/E07.085

(57) ABSTRACT

A camera module having a housing having a predetermined periphery with a plurality of cameras secured within the periphery of the housing, each camera having a lens positioned to have a desired field of view to the exterior of the housing and electrical communication elements within the housing for providing electrical communication between the cameras to the exterior of the housing.

### CROSS-REFERENCE TO RELATED APPLICATIONS

This application is related to U.S. patent application entitled “Method of Providing Camera Views about an Object or Area”, attorney docket No. 10049 and U.S. patent application entitled “System for Providing Camera Views”, attorney docket No. 10059 both of which are assigned to the same assignee as the assignee herein, filed concurrently herewith and hereby incorporated by reference.

### BACKGROUND OF THE INVENTION

The present invention relates generally to miniature camera modules and more particularly to an inexpensive low-profile camera module that provides omnidirectional, panoramic, panospheric and/or hemispherical views.

### SUMMARY OF THE INVENTION

A camera module having a housing having a predetermined periphery with a plurality of cameras secured within the periphery of the housing, each camera having a lens positioned to have a desired field of view to the exterior of the housing and electrical communication elements within the housing for providing electrical communication between the cameras to the exterior of the housing.

### DESCRIPTION OF THE DRAWINGS

The following detailed description will be better understood when read in conjunction with the appended drawings, in which there is shown one or more of the multiple embodiments of the present disclosure. It should be understood, however, that the various embodiments of the present disclosure are not limited to the precise arrangements and instrumentalities shown in the drawings.

FIG. 1. is a perspective view illustrating one embodiment of the camera module of the present invention;

FIG. 2. is a front plan view illustrating the camera module of FIG. 1 attached to an unmanned vehicle, such as a robot;

FIG. 3. is a perspective view illustrating one or more of the camera modules of FIG. 1 attached to another type of unmanned vehicle;

FIG. 4 is a is a perspective view of a head mounted display illustrating multiple camera modules of the present invention secured thereto;

FIG. 5 is a partial cross-sectional view of the camera module of the present invention substantially taken along lines 5-5 of FIG. 1;

FIG. 6 is a top view taken a predetermined distance above the module of FIG. 1 substantially illustrating the overlapping fields of view of the cameras;

FIG. 7. is a partial top view of the unmanned vehicle of FIG. 3 illustrating one embodiment of the potential field of view of the camera modules;

FIG. 8 is a perspective view illustrating multiple camera modules of the present invention attached to another type of vehicle such as an aircraft;

FIG. 9 is a perspective view illustrating multiple camera module of the present invention attached to another type of vehicle such as a military vehicle;

FIG. 10 is a perspective view illustrating multiple camera modules of FIG. 1 attached to another version of an unmanned vehicle; and

FIG. 11 is a perspective view of a helmet worn by a human having multiple camera modules of FIG. 1.

### DESCRIPTION OF THE PREFERRED EMBODIMENTS

The present invention will be described in detail with reference to embodiments that represent examples of the present invention and are not intended to limit the scope of the invention. Although specific elements and configurations are described to provide an understanding of the invention, it is to be understood that the specific embodiments, elements and configurations provided are for illustrative purposes only. Other configurations will be recognized by those of ordinary skill in the art without departing from the teachings of the present invention or the scope of the appended claims.

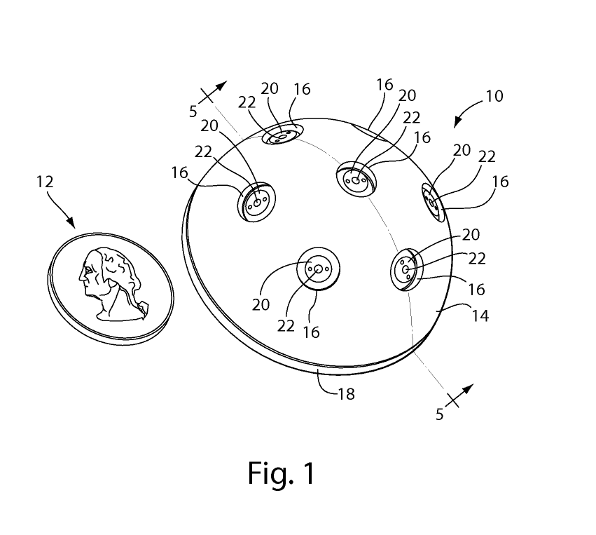

Referring to FIG. 1, one embodiment of the camera module of the present invention is generally illustrated by reference numeral 10. The module 10 is illustrated having a generally hemispherical shape, although the size and shape may vary, and may be a miniature module or the like as is illustrated in FIG. 1 with respect to a United States quarter dollar 12.

Although not illustrated, the module 10 may also be in the form of a hemispheroid, either oblate (earth shaped) or prolate (rugby football shaped), or in the form of a plurality of substantially flat or oblique surfaces joined together to form similar types of shapes. Although the module 10 preferably is formed as an oblique object, it is to be understood that the module 10 can have a variety of shapes and sizes without departing from the teachings of the present invention or the appended claims.

The unique shape and size of the module 10 itself enables a number of novel features to be realized by the present invention. These features, among others, include overlapping fields of view for multiple redundancy, a direct camera view for virtually every direction, unobtrusive and inconspicuous operation to resist or eliminate being blocked, detected and/or disabled, and substantially oblique surfaces that, combined with the material of the module 10, can resist disablement from a foreign object or the like as will be described in more detail herein.

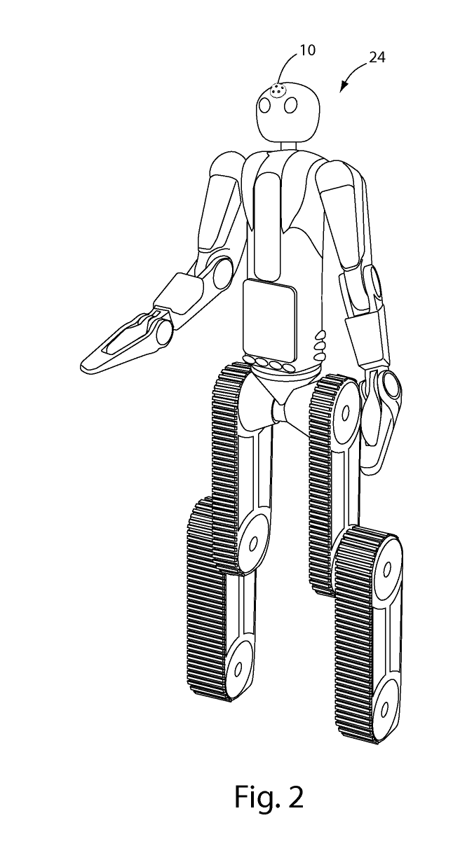

The module 10 substantially includes a hemispherical housing 14 having a plurality of apertures 16 therethrough and a substantially flat surface 18 for mounting of the module 10 against a desired article (generally illustrated in FIGS. 2-4). The module 10 also includes a plurality of cameras 20, each camera 20 being preferably secured within the confines of the housing 14 so that a lens 22 of each camera 20 provides a desired field of view through a respective aperture 16. Although the module 10 is illustrated with seven cameras 20, the number of cameras 20 and their position with respect to the housing 14, the fields of view and the lenses provided, among other features, may vary.

The housing 14 is designed as a substantially hollow, hemispherical member with a desired thickness and can be formed from any desired material such as plastic or metal (including steel or titanium, for example) or the like as well as a variety of composite materials, including any type of bullet resistant or bullet proof materials such as Kevlar, Lexan or the like so long as the module 10 functions as desired. The housing 14 may also be used in outdoor environments by making it water resistant or waterproof by making it completely sealed against the environment and may be protected by any type of desired armor. It is to be understood, however, that the material of the housing 14, or any other elements or features of the housing 14, may vary without departing from the teachings of the present invention or the appended claims.

If desired, the module 10 may be designed to be completely self-contained with all electronics included inside the housing 14 such as microprocessor(s), data storage, memory, power and external communications such as by any wireless method including Bluetooth, for example. With such a design, all processing of the videos from the various cameras 20 can be accomplished by the module 10 itself, including stitching together multiple or all of the various views of the cameras 20 into one data stream to be stored within, or transmitted to the exterior of, the module 10.

Alternatively, individual views of the cameras 20 can be provided in separate video streams for internal storage or external transmission. With such a design, individual camera views can be selected for viewing and two or more selected views can be stitched for composite viewing.

Although the flat surface 18 of the housing 14 is not illustrated in detail, the flat surface 18 may allow for access to the interior of the housing 14 for mounting or replacement of the cameras 20 therein such as by the use of an openable or removable plate, door or the like or any other type of access. The housing 14 may also include a mounting structure or element (not illustrated) either as part of the flat surface 18 or any other part of the housing 14 including, but not limited to, such mounting methods as screws, brackets, clips, adhesives, and hook-and-loop fasteners, for example.

The apertures 16 of the housing 14 may be through-apertures having the same diameter through the housing 14, may be tapered or take on any other desired size, shape or configuration. Alternatively, the apertures 16 may be replaced with pockets (not illustrated) formed in the housing 14 to accept the cameras 20 therein.

FIG. 2 illustrates one embodiment of the module 10 mounted to an unmanned vehicle such as a robot 24 or the like where the module 10 and cameras 20 can be used in a “visual odometry” type of application where the position, operation and/or orientation of the robot 24 is determined by analyzing images from one or more cameras 20. If desired, multiple modules 10 (not illustrated) may also be used with the robot 24 to provide multiple views from a variety of positions about the robot 24.

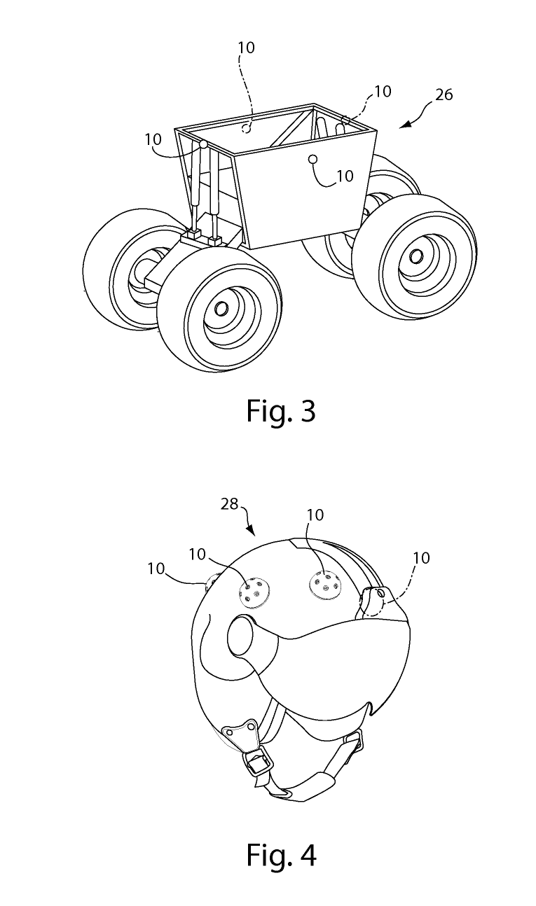

As FIG. 3 illustrates, one or more modules 10 may also be mounted to an unmanned transport vehicle 26 intended for transporting items or the like. When the transport vehicle 26 is in the form of a substantially rectangular object as illustrated, the views of the modules 10 enable multiple overlap between modules 10 as described below with regard to FIG. 7.

As FIG. 4 illustrates, one or more modules 10 may also be used in conjunction with a head mounted display 28 illustrated in the form of a helmet. It is to be understood, however, that the number and position of modules 10 utilized at any time can vary and the module 10 may be utilized in a variety of applications other than those illustrated.

The use of a module 10 along with multiple cameras 20 and/or multiple modules 10 and the design and shape of the modules 10 themselves represents a dramatic shift away from current remote camera design and application. For example, by providing multiple cameras 20 in a module 10 arranged according to the teachings of the present invention a new level of redundancy in camera views is achieved in the event of a malfunction of one or more of the cameras 20 as will be described further below. Intentional or unintentional disablement of the module 10 can also be more difficult since, due to the overlapping views, each camera 20 in each module 10 must be disabled to prevent a desired view and access to each camera 20 or module 10 may be difficult or too time consuming, for example.

By using multiple modules 10, an additional level of redundancy in camera views can be provided according to the teachings of the present invention by providing multiple sets of cameras 20 in multiple, separate locations selected to provide a heightened level of view redundancy or overlap. This not only can be beneficial in the event of the malfunction or disablement of one or more cameras 20, but in the malfunction or disablement of one or more modules 10.

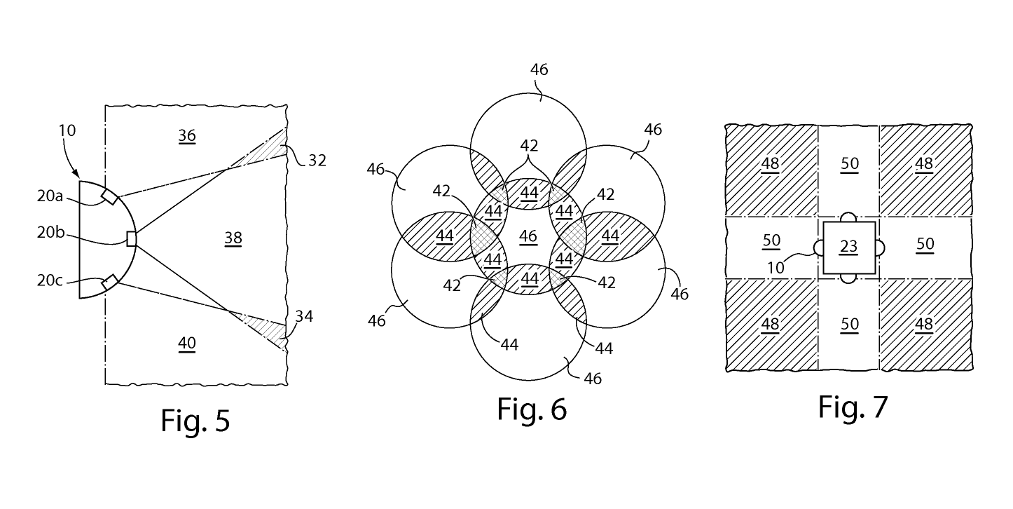

As an example of the unique overlapping view feature of the present invention, FIG. 5 is a cross-sectional view of the module 10 illustrating one embodiment of the module 10 and one potential overlap of just three camera views where a cross-hatched section 30 represents coverage by all three cameras 20a, 20b and 20c. As can readily be understood, a first single lined section 32 represents coverage by just two cameras 20a and 20b and a second lined section 34 represents coverage by just two cameras 20b and 20c. Coverage by just a single camera is represented by unlined sections 36, 38 and 40 covered by cameras 20a, 20b and 20c respectively.

Although not particularly drawn to exact shape or scale, FIG. 6 is a partial top view taken at a predetermined position above the module 10 of FIG. 1 illustrating one embodiment of the potential overlap of all seven camera views of the cameras 20 of module 10 which are not illustrated in this figure. As can readily be understood, the six cross-hatched sections 42 represent coverage by three cameras (not illustrated), the 12 singled lined sections 44 represent coverage by just two cameras and the seven unlined sections 46 represent coverage by just a single camera.

Similarly, with reference to FIG. 7, when multiple modules 10 are used on a rectangular object such as the transport vehicle 26 significant portions about the transport vehicle 26 are covered by two modules 10. In this embodiment, coverage by two modules 10 is illustrated by the four single lined sections 48 while coverage by just one module 10 is illustrated by the four unlined sections 50. Of course, for each module 10 seven cameras 20 provide the desired hemispherical view with overlapping fields of view as described above.

With multiple modules 10, intentional or unintentional disablement of one or more modules 10 is more difficult or unlikely. This is particularly important when the modules 10 are used in a security surveillance setting or in conjunction with a robot or other type of unmanned vehicle or craft and even more so in a combat environment. Specifically, when used in a robot or the like, when the camera viewing system is inoperable or disabled the robot is unable to function and if remotely controlled the user is unable to continue to “see” where the robot is and/or needs to be moved.

When used in a hostile environment, such as a surveillance setting or combat zone, an entity who may be interested in disabling the robot can merely take measures to attempt to disable a the camera 20, such as with a projectile, cover, spray paint, implement or other member. With multiple modules 10, while an entity may disable one or more modules 10 the operator may still be able to utilize an existing module 10 not discovered or disabled by an entity to move the robot out of the area.

The design of the module 10 itself also adds to the ability of an operator to maintain control over a robot. The small size of the module 10 provides an extremely low profile making the module 10 unobtrusive and relatively inconspicuous compared to existing modules. If desired, the module 10 can also be camouflaged to blend in with a particular background as illustrated in FIG. 1 to make it even more difficult to spot and potentially disable.

The hemispherical, hemispheroid or other oblique design of the module 10 aids in preventing disabling the module 10 by providing oblique surfaces that may deflect a projectile or implement. This shape also makes breaking off of the module 10 from a surface it is attached to more difficult, particularly if some type of security resistant mounting is employed. When the oblique surfaces of the module 10 are combined with the module 10 being formed from a strong material, such as metal or a bullet resistant or bullet proof material or the like, disabling of the module 10 from a projectile or implement is less likely.

As readily can be understood from FIG. 1, due to the positioning of the cameras 20 about the module 10, when the video of each camera 20 is combined a hemispherical, panoramic or “panospheric” view (hereinafter “view” or “hemispherical view”) about the module 10 is provided. The view may extend up to at least 180 degrees in any direction about the periphery of the module 10 but may vary depending on the types of cameras 20 and lenses 22 utilized and the positions about the housing 14.

When multiple modules 10 are used, such as shown with the head mounted display 28 of FIG. 4, for example, the view about the periphery of the display 28 extends well beyond 180 degrees. Although four modules 10 are illustrated, any number of modules 10 can be positioned on the robot 24 or transport vehicle 26 so that a full 360 degree view is provided about the robot 24 or transport vehicle 26.

The cameras 20 can be any type of camera, video or still, so long as they function as desired, including, but not limited to cameras having a micro lens, miniature and subminiature cameras, fiber optic cameras, CCD cameras, active pixel or CMOS image sensors, or the like including future camera types and styles. Additionally, various software required to “stitch” the various views together is readily available or can be independently developed to fit the particular application.

Preferably, the cameras 20 are not high cost cameras, rather, lower cost cameras 20 are utilized the resolution of which depends on the particular application. In many applications, the quality of the image being captured is not necessarily the most important criteria, rather, capturing a desired image with an acceptable level of quality is all that is necessary.

The use of a plurality of lower resolution cameras 20 represents an important shift in the art that enables the desired views in a more economical package to enable applications that previously were cost prohibitive. The cost of modules 10 with lower resolution cameras 20 can be low enough to enable modules 10 to be disposable if desired.

A variety of electronics and power supply (not illustrated) may be used along with the cameras 20 to provide the desired view. The electronics and power supply may be contained within the confines of the housing 14 or outside the housing 14 such as within a portion of the robot 24, transport vehicle 26, or head mounted display 28 or in a separate unit utilized in conjunction with the robot 24, transport vehicle 26 or head mounted display 28. The electronics may be hard wired to the cameras 20 and other peripheral devices or be connected wirelessly, if desired.

The module 10 preferably is designed as a self-contained readily replaceable unit to assist in initial mounting and subsequent repair by merely replacing the module 10. In this respect, the module 10 can be used substantially as an interchangeable platform for use with multiple vehicles or other objects as is more frequently being requested in military or other operations to reduce costs incurred from the use of multiple platforms.

Additionally, a minimal amount of electronics may be included with the cameras 20 or within the housing 20 for wireless communication with a variety of external peripheral devices. Such devices may include, for example, remote displays, microprocessor controlled devices, various user input/output devices or the like. External viewing can be a composite view of all of the cameras 20, the view of any individual camera 20 or any combination of two or more video cameras 20 if desired.

In one preferred embodiment, the view provided by the cameras 20 may be fed to an operator or other individual or individuals at a location proximate to or remote from the module(s) 10. This view can, for example, be used to manipulate the robot 24 or transport vehicle 26 about various terrain and environments or to accomplish various tasks. It is to be understood that to manipulate the robot 24 or transport vehicle 26 discrete electronic and power systems separate from the electronics of the module 10 may be employed.

Additionally, the head mounted display 28 of FIG. 4 may be used by a wearer to provide a full view about the viewer to both the viewer as well as one or more individuals at remote locations. Although the head mounted display 28 is illustrated with four modules 10 positioned on the front, rear and two sides respectively, it is to be understood that the number and position of the modules 10 can vary.

One of the many important features of the module 10 is the ability to simultaneously capture and display all data with regard to all views of each camera 20 in real time or substantially real time. This enables viewers at remote locations to choose one or more cameras 20 to select the view or composite view they are interested in viewing regardless of the direction the wearer is facing. This may enable the remote viewers to draw the attention of the wearer to another direction that may be of interest to them or to watch one or more directions for the safety of the wearer, such as in a military, police or similar applications.

Additionally, since various camera views from multiple cameras 20 are simultaneously captured or “pre-loaded”, delays in changing views with the head mounted display 28 upon turning of the wearer's head or turning of the robot 24 or transport vehicle 26 is reduced or eliminated. When using a single camera rather than multiple cameras 20 as in the present invention there will be a lag or delay in views when the camera is moved which is undesirable and perhaps dangerous in certain applications.

Similarly, when multiple modules 10 are utilized providing various views from multiple cameras 20 from each module 10, the various camera views from multiple cameras 20 are simultaneously captured or “pre-loaded” to eliminate delays in views. This is an important feature for not only the head mounted display 28 but also the robot 24 and transport vehicle 26.

For example, with a head mounted display 28 if only one module 10 is used the views provided by the multiple cameras 20 is more of a panoramic or “panospheric” view that extends in a hemispherical direction substantially in the direction the module is facing. As the wearer turns his/her head say to the left, the view that previously was on the left periphery of the wearer now becomes the front view with respect to the wearer. At the same time, a new left periphery view is provided to the wearer or remote viewer.

When using multiple modules 10, the wearer is always provided with a clear view of the direction he/she is facing. It also enables a wearer to more quickly move his/her head back and forth without losing the view of the direction he/she is facing.

Another important feature of the module 10 is the ability to enable more placement positions with respect to an object, such as the robot 24 or transport vehicle 26. This is not only due to the substantially small size of the module 10 but due to the use of multiple modules 10 that break up the 360 degree view into several hemispherical views that may overlap each other to provide redundant or overlapping views. Typically, in existing applications if single or multiple cameras are provided in a central location (not illustrated) for fixed position or rotation to provide a wide view up to 360 degrees, that view readily can be blocked during operation of the robot 24 or transport vehicle 26 by components of the robot 24 or transport vehicle 26.

The relatively small sizes capable of the module 10 enable more placement positions on an object to provide increased number of views or placement where a camera system typically may not fit. Additionally, due to the small size of the module 10 it can be placed closer to an object or surface to reduce the size of any potential blind spot that may occur near the object or surface itself.

When multiple modules 10 are used with a robot 24 or other unmanned transport vehicle 26 since the robot 24 or vehicle 26 can typically move in multiple directions, when one module 10 is broken or disabled the robot 24 or vehicle 26 can still function. In this situation, an operator can merely switch views to another module or modules 10 and merely direct the robot 24 or vehicle 26 to move in another direction while the operator can still manipulate the robot 24 or vehicle 26 as desired.

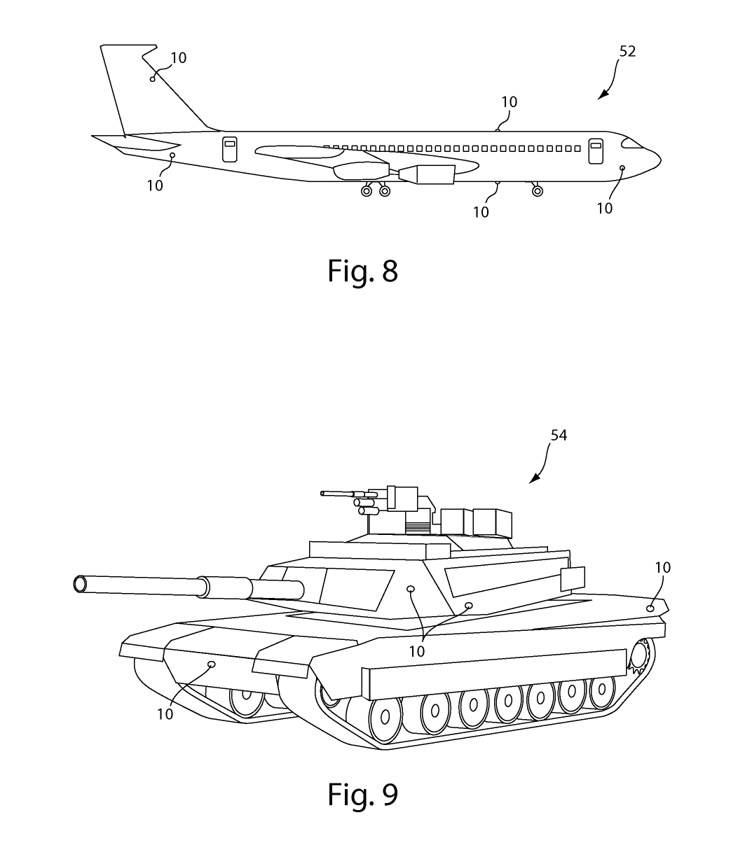

As FIG. 8 illustrates, one or more modules 10 may also be used in conjunction with an aircraft, such as an airplane 52. Placement of modules 10 in selection areas about the airplane 52 can assist the pilot or other personnel in remote locations to monitor areas of the airplane 52 either in flight or on the ground for potential problems such as damage, fire, landing gear position or the like.

Such modules 10 may also provide important information in the event of a crash of an airplane 52 so that the particular reason for a crash can be identified and corrective actions taken to reduce such crashes. The video from modules 10 can either be stored along with the existing black boxes currently being used or transmitted to and/or stored at remote locations via satellite or other type of communications systems.

When the video is transmitted to a remote location, the video may also be used to control various types of aircraft and provide surveillance as desired. It is to be understood that the modules 10 can be used with a variety of aircraft, both manned and unmanned, military or private, including but not limited to helicopters, balloons, rockets, munitions and spacecraft, for example.

FIG. 9 illustrates one or more modules 10 are illustrated in use with a military vehicle, such as a tank 54 but any type of vehicle military or otherwise may be used with the modules 10 of the present invention. By placing one or more modules 10 about the periphery of the tank 54, an operator inside the tank 54 can utilize a head mounted display, such as display 28 illustrated in FIG. 4, for example, to operate the tank 54 and weapons on the tank 54 without having to look outside.

Thus, if desired, the tank 54 can be completely sealed from the exterior which can be advantageous in the event of some type of airborne contaminant, such as a chemical weapon or the like. Additionally, if the tank 54 is operated remotely by one or more individuals, the tank can be unmanned to save the lives of soldiers while enabling movement and weapons usage of the tank 54.

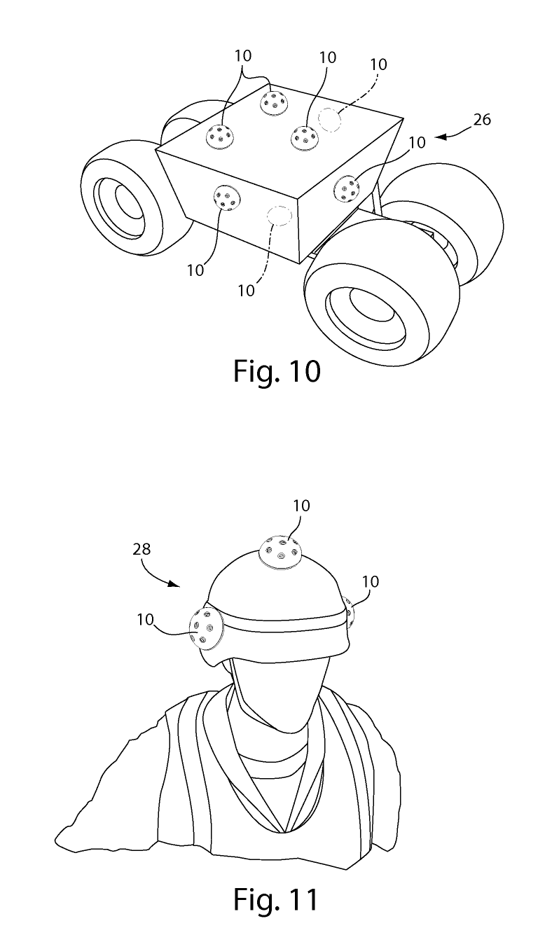

FIG. 10 illustrates another version of an unmanned transport vehicle 26 having multiple camera modules 10 of the present invention secured thereto. In this embodiment, modules 10 are positioned on all four sides of the vehicle 26 as well as the bottom and three modules 10 are positioned on the top of the vehicle 26. With this arrangement, additional views are provided which aids in providing even more redundancy as well as selective remote viewing about the vehicle 26, among other features.

FIG. 11 illustrates another version of the helmet 28 being worn by a user such as a soldier or the like. This enables multiple views about the soldier to be communicated to a remote location for viewing or processing. Additionally, if desired the views can be provided to the soldier such as with an electronic eye piece (not illustrated) or display or the like as illustrated in FIG. 4

The embodiments of the present disclosure may be implemented with any combination of hardware and software. If implemented as a computer-implemented apparatus, the embodiments of the present disclosure are implemented using means for performing all of the steps and functions described above.

The embodiments of the present disclosure can be included in an article of manufacture (e.g., one or more computer program products) having, for instance, computer useable media. The media has embodied therein, for example, computer readable program code means for providing and facilitating the mechanisms of the embodiments of the present disclosure. The article of manufacture can be included as part of a computer system or sold separately.

Although the description above contains many specific examples, these should not be construed as limiting the scope of the embodiments of the present disclosure but as merely providing illustrations of some of the presently preferred embodiments of this disclosure. Thus, the scope of the embodiments of the disclosure should be determined by the appended claims and their legal equivalents, rather than by the examples given.

It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the embodiments of the present disclosure.

I claim:

1. A camera module, comprising:
a housing having a predetermined periphery;
a plurality of cameras secured within the periphery of the housing, each camera having a lens positioned to have a desired field of view to the exterior of the housing; and
electrical communication elements within the housing for providing electrical communication between the cameras to the exterior of the housing.

2. The module as defined in claim 1, wherein the housing has at least one planar surface for mounting of the module against another surface.

3. The module as defined in claim 1, where data streams of each camera are combined within the housing and one composite data stream is transmitted to the exterior of the housing.

4. The module as defined in claim 1, wherein the fields of view can be combined to provide up to a 180 degree hemispherical view about the housing.

5. The module as defined in claim 1, wherein the housing is a substantially hemispherical shaped housing and a flat portion of the housing can be secured against the surface of an object.

6. The module as defined in claim 1, wherein the housing is a low profile design to prevent potential interference with other objects.

7. The module as defined in claim 1, wherein each field of view of each camera lens overlaps with the field of view of at least 4 other fields of view from other camera lens.

8. The module as defined in claim 1, wherein the module is designed to have an inconspicuous shape.

9. The module as defined in claim 1, wherein the module is designed as a completely self-contained module for use as a stand-alone device that can readily be implemented and/or interchanged as desired.

10. The module as defined in claim 1, wherein the module is designed to have an oblique shape.

11. The module as defined in claim 1, wherein the module is designed to have an unobtrusive shape.

12. A camera module, comprising:
a housing having a predetermined periphery and a plurality of apertures therethrough positioned in a predetermined pattern;
a plurality of cameras secured within the confines of the housing, one camera for each aperture and each camera having a lens positioned to have a desired field of view through a respective aperture to the exterior of the housing; and
electrical communication elements within the housing for providing electrical communication between the cameras to the exterior of the housing.

13. The module as defined in claim 12, wherein the housing has at least one planar surface for mounting of the module against another surface.

14. The module as defined in claim 12, where data streams of each camera are combined within the housing and one composite data stream is transmitted to the exterior of the housing.

15. The module as defined in claim 12, wherein the fields of view can be combined to provide up to a 180 degree hemispherical view about the housing.

16. The module as defined in claim 12, wherein the housing is a substantially hemispherical shaped housing and a flat portion of the housing can be secured against the surface of an object.

17. The module as defined in claim 12, wherein the housing is a low profile design to prevent potential interference with other objects.

18. The module as defined in claim 12, wherein each field of view of each camera lens overlaps with the field of view of at least 4 other fields of view from other camera lens.

19. The module as defined in claim 12, wherein the module is designed to have an inconspicuous shape.

20. The module as defined in claim 12, wherein the module is designed as a completely self-contained module for use as a stand-alone device that can readily be implemented and/or interchanged as desired.

21. The module as defined in claim 12, wherein the module is designed to have an oblique shape.

22. The module as defined in claim 12, wherein the module is designed to have an unobtrusive shape.

23. The module as defined in claim 12, wherein each view can be separately viewed.

24. The module as defined in claim 12, wherein the housing is designed to be positioned proximate to a surface to eliminate any potential blind spots proximate the surface.

25. The module as defined in claim 12, wherein the centerline of each field of view of each camera is positioned non-parallel with respect to the centerlines of every other camera field of view.

26. The module as defined in claim 12 wherein the centerline of each field of view of each camera is positioned non-perpendicular with respect to the centerlines of every other camera field of view.
